(19) United States
(12) Patent Application Publication
(10) Pub. No.: US 2023/0227698 A1
(43) Pub. Date: Jul. 20, 2023

(54) Hard Coat Compositions and Composite Films Including a Thermoplastic Polyurethane

(71) Applicant: 3M INNOVATIVE PROPERTIES COMPANY, St. Paul, MN (US)

(72) Inventors: Yongshang Lu, Woodbury, MN (US); Charlie C. Ho, Woodbury, MN (US)

(21) Appl. No.: 17/928,953

(22) PCT Filed: Jun. 2, 2021
(86) PCT No.: PCT/IB2021/054838

§ 371 Date: Dec. 1, 2022

Related U.S. Application Data
(60) Provisional application No. 63/045,424, filed on Jun. 29, 2020.

(51) Int. Cl. C09J 7/29; C08G 18/42; C08G 18/32; C08G 18/66; C08G 18/75; C09J 7/38; C09J 7/35

(52) U.S. Cl. CPC C09J 7/29; C08G 18/4213; C08G 18/3206; C08G 18/3212; C08G 18/664; C08G 18/75; C09J 7/38; C09J 7/35; C09J 2475/006; C09J 2301/302; C09J 2301/304

(57) ABSTRACT

Disclosed herein are hard coat compositions and composite films including a thermoplastic polyurethane. A hard coat composition includes a thermoplastic polyurethane having a hard segment content of 80 percent by weight or greater. The thermoplastic polyurethane is a reaction product of a) a diisocyanate; b) a polyol optionally comprising a cyclic structure; and c) a chain extender. At least one of the polyol or the chain extender comprises at least one side chain and at least one of the diisocyanate or the chain extender comprises a cyclic structure. A composite film includes 1) a hard coat layer having opposing first and second major surfaces; and 2) a second layer disposed on at least a portion of the hard coat layer. These materials can serve decorative and/or protective functions while displaying both good elongation at moderate temperatures and high hardness.

### FIELD OF THE INVENTION

Provided are hard coat compositions, and films derived therefrom. More particularly, the provided polyurethane compositions are thermoplastic polyurethanes suitable for protective and decorative film applications.

### BACKGROUND

Polyurethanes represent a broad family of polymers with great commercial and industrial importance. While these materials can be formulated to have a wide range of material properties, polyurethanes are well known for their abrasion resistance, toughness, flexibility, impact resistance, tear strength, and chemical resistance. Principal applications include films, coatings, elastomers, and foams. Films and coatings can be especially advantageous in protecting substrates from environmental weathering, chemical exposure, heat, and/or abrasion. Polyurethanes can also be engineered to be highly transparent and, if desired, can be formed into films and coatings with graphic arts for decorative applications.

Chemically, polyurethanes are distinguished by their characteristic carbamate (—NH—CO—O—) linkages and are generally prepared by reacting a multifunctional isocyanate with a multifunctional diol, or more generally polyol, with the presence of a catalyst. There are two general types of polyurethanes, thermoset and thermoplastic. Thermoset polyurethanes are highly crosslinked by covalent bonds. Thermoplastic polyurethanes are characterized by linear polymeric chains having self-ordering block structures. These polyurethanes are generally uncrosslinked but can also be lightly crosslinked. The block structures of a thermoplastic polyurethane generally include alternating “hard” and “soft” segments covalently bonded to each other end-to-end. The hard segments aggregate to form crystalline regions that act like physical crosslinks at ambient temperatures, but convert to a molten state upon heating. As a result, thermoplastic polyurethanes are well suited for thermoforming onto three dimensional articles and can be easily reprocessed.

Certain advantageous applications of polyurethanes relate to their use in hard coat applications. These include, for example, paint protection films or paint replacement films that protect the exterior surface of an automotive vehicle from harsh environmental conditions. Such conditions include impingement from stones, sand, debris, and insects, as well as general outdoor weathering, which can substantially degrade an automotive exterior overtime. Composite polyurethane films have been previously described in U.S. Pat. No. 5,405,675 (Sawka et al.); U.S. Pat. No. 5,468,532 (Ho et al.); U.S. Pat. No. 6,607,831 (Ho); U.S. Pat. No. 6,383,644 (Fuchs); and International Patent Publication Nos. WO 2008/042883 (Ho et al.) and WO 2016/018749 (Ho et al.).

### SUMMARY

With respect to hard coat applications, thermoset and thermoplastic polyurethane materials present competing advantages and drawbacks. Thermoplastic paint protection films can meet minimum performance requirements but stand to benefit from increased stain resistance, chemical resistance, and ultraviolet light (UV) stability. Thermoset polyurethanes generally display a high degree of stain, chemical, and UV resistance but require multiple coating steps, driving up manufacturing costs, and has a high film modulus that can impede its ability to stretch and conform to the irregular contours of an automotive vehicle. Moreover, achieving both a high degree of hardness and elongation simultaneously is a technical problem that has not been adequately addressed by prior art thermoplastic polyurethane materials.

Disclosed herein are improved thermoplastic polyurethane compositions, articles, and related methods. These compositions were found to display surprisingly high stain, abrasion, scratch, UV, and resistance to glass treatment chemicals when compared to existing hard coat compositions. The processibility of these materials makes them particularly suitable for dual vacuum thermoforming (sometimes referred to as vacuum contact bonding) parts for protective and decorative applications. Moreover, these polyurethanes show excellent adhesion to softer reactive extruded thermoplastic polyurethane coatings, enabling hybrid composite film constructions with a variety of potential applications, ranging from black out film to dual vacuum thermoformed parts.

In a first aspect, a hard coat composition is provided. The hard coat composition comprises a thermoplastic polyurethane having a hard segment content of 80 percent by weight or greater. The thermoplastic polyurethane is a reaction product of a) a diisocyanate; b) a polyol optionally comprising a cyclic structure; and c) a chain extender. At least one of the polyol or the chain extender comprises at least one side chain and at least one of the diisocyanate or the chain extender comprises a cyclic structure.

In a second aspect, a composite film is provided. The composite film comprises 1) a hard coat layer comprising opposing first and second major surfaces; and 2) a second layer disposed on at least a portion of the hard coat layer. The hard coat layer comprises a thermoplastic polyurethane having a hard segment content of 80 percent by weight or greater. The thermoplastic polyurethane is a reaction product of a) a diisocyanate, b) a polyol optionally comprising a cyclic structure, and c) a chain extender. At least one of the polyol or the chain extender comprises at least one side chain and at least one of the diisocyanate or the chain extender comprises a cyclic structure.

### BRIEF DESCRIPTION OF THE DRAWINGS

FIGS. 1-4 show cross-sectional schematic elevational views of composite films according to various embodiments.

### DEFINITIONS

As used herein:

“ambient conditions” means at a temperature of 25 degrees Celsius and a pressure of 1 atmosphere (approximately 100 kilopascals);

“catalyst” means a substance that can increase the speed of a chemical reaction;

“diol” means a compound having a hydroxyl functionality of exactly two;

“diisocyanate” means a compound having an isocyanate functionality of exactly two;

“harden” means to alter the physical state and or chemical state of the composition to make it transform from a fluid to less fluid state, to go from a tacky to a non-tacky state, to go from a soluble to insoluble state, to decrease the amount of polymerizable material by its consumption in a chemical reaction, or go from a material with a specific molecular weight to a higher molecular weight;

“hardenable” means capable of being hardened;

“polyisocyanate” means a compound having an isocyanate functionality of two or more;

“polyol” means a compound having a hydroxyl functionality of two or more;

“short-chain diol” means a diol having a weight average molecular weight of at most 185 grams per mole (g/mol); and

“side chain”, relative to a “backbone” or “main chain” is a group of two or more atoms that branch off from the straight chain of carbon atoms formed by polymerization.

### DETAILED DESCRIPTION

As used herein, the terms “preferred” and “preferably” refer to embodiments described herein that may afford certain benefits under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art.

It is noted that the term “comprises” and variations thereof do not have a limiting meaning where these terms appear in the accompanying description. Moreover, “a,” “an,” “the,” “at least one,” and “one or more” are used interchangeably herein.

Relative terms such as left, right, forward, rearward, top, bottom, side, upper, lower, horizontal, vertical, and the like may be used herein and, if so, are from the perspective observed in the particular figure. These terms are used only to simplify the description, however, and not to limit the scope of the invention in any way. Figures are not necessarily to scale.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” throughout this specification are not necessarily referring to the same embodiment of the invention. Furthermore, the particular features, structures, materials, or characteristics may be combined in any suitable manner in one or more embodiments.

### Film Constructions

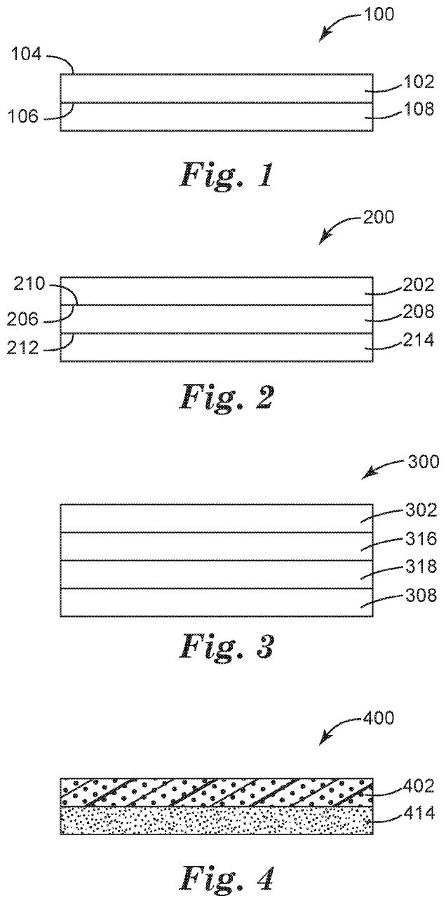

In an aspect, a composite film is provided comprising:
1) a hard coat layer comprising opposing first and second major surfaces, the hard coat layer comprising a thermoplastic polyurethane having a hard segment content of 80 percent by weight or greater, wherein the thermoplastic polyurethane is a reaction product of a) a diisocyanate, b) a polyol optionally comprising a cyclic structure, and c) a chain extender, wherein at least one of the polyol or the chain extender comprises at least one side chain and at least one of the diisocyanate or the chain extender comprises a cyclic structure; and
2) a second layer disposed on at least a portion of the hard coat layer.
   A composite film according to one exemplary embodiment is illustrated as a schematic in FIG. 1 and designated by the numeral 100. The composite film 100 includes a hard coat layer 102 having a first major surface (e.g., top surface) 104 and an opposing second major surface (e.g., bottom surface) 106. The composite film 100 further includes a second layer 108 disposed on the hard coat layer 102, extending across the second major surface 106 of the hard coat layer 102. Optionally and as shown, the second layer 108 and hard coat layer 102 are laminated to each other such that the layers 102, 108 directly contact each other along essentially the entire second surface 106. If desired, the second layer 108 may contact the hard coat layer 102 along only a portion of the second surface 106.

In some embodiments, the second layer 108 is an adhesive layer, for instance an adhesive layer comprising a pressure sensitive adhesive, a hot melt adhesive, or a combination thereof. In some embodiments, the second layer 108 is a (e.g., non-adhesive) polymeric layer, for instance a polymeric film or self-supporting substrate. Suitable polymeric materials for the polymeric layer may comprise a polyurethane or polyethylene terephthalate (PET).

While the second layer 108 is depicted as having a rectilinear geometry in FIG. 1, it may take on any of a number of different configurations. For example, the second layer 108 may have three-dimensional contours that include regions of positive and/or negative curvature. Exemplary second layers include sheets, decorative articles, graphics, and combinations thereof. Even if the second layer 108 is formed as a flat sheet, it can be subsequently die-cut, thermoformed, embossed, or otherwise formed into a shape different from its original shape. While not shown in FIG. 1, an adhesive or mechanical device could be used to fasten the second layer 108 to a separate substrate.

The hard coat layer 102 can be provided in any suitable thickness based on the application at hand. Typically, the hard coat layer 102 has a thickness that ranges from 5 micrometers to 300 micrometers. A typical overall film thickness for protective films formed over automotive body panels is at least 50 micrometers, at least 75 micrometers, or at least 100 micrometers. In the same or alternative embodiments, film thickness is at most 1.27 millimeters, at most 1.1 millimeters, or at most 1.0 millimeters.

FIG. 2 shows a schematic of a composite film 200 according to another embodiment having three layers instead of two. Like the embodiment of FIG. 1, the composite film 200 includes a hard coat layer 202 and second layer 208 disposed on the hard coat layer 202, contacting each other along a second surface 206 of the hard coat layer 202. The second layer 208 has a first major surface (e.g., a top surface) 210 and an opposing second major surface (e.g., a bottom surface) 212. In this embodiment, the second layer 208 may be a polymeric layer and the composite film further comprises an adhesive layer 214 that contacts and extends along the second major surface 212 of the second layer 208.

FIG. 3 shows a schematic of a composite film 300 according to still another embodiment in which a hard coat layer 302 is attached to a primer layer 316, which is in turn attached to a color coating 318, which is in turn disposed on a second layer 308. Accordingly, the primer layer 316 is disposed between the hard coat layer 302 and the color coating layer 318, and the color coating layer 318 is disposed between the hard coat layer 302 and the second layer 308. The color coating 318 may comprise for instance, one or more of a metallic vapor coat, an acrylic color coat, or a polymeric binder and a colorant. The polymeric binder may be a thermoplastic or a thermoset. Typically, the composite film 300 exhibits a haze of 2.5% or less, 2.0% or less, 1.5% or less, or 1.0% haze or less. The haze can be measured by any suitable method. In some embodiments, haze measurements can be determined by using a BYK Haze-Gard Plus (BYK Gardner USA, Columbia, Md.). Measurements are taken at six different spots on each composite film sample and averaged.

One or more additional layers may be coated or laminated to either major surface of the composite film. Alternatively, one or more intermediate layers may be interposed between any two adjacent layers present in the composite film. Such layer or layers may be similar to those described above or may be structurally or chemically distinct. Distinct layers could include, for example, extruded sheets of a different polymer, metal vapor coatings, printed graphics, particles, and primers, and may be continuous or discontinuous. For example, in FIG. 2, a tie layer may be disposed between the second layer 208 and the adhesive layer 214 to improve the quality of adhesion between the two layers.

If desired, the composite film 100, 200, 300 could be laminated onto a substrate, such as a vehicular body panel, with the second layer 108, 208, 308 contacting the substrate to provide a coated article. Alternatively, the second layer 108, 208, 308 could be provided in a configuration in which it is already adhered or otherwise coupled to the substrate. In some embodiments, the substrate is a polymeric substrate having three-dimensional contours. Useful substrates may include, for example, injection molded substrates having a shape of an interior component in an automotive vehicle.

FIG. 4 shows a bilayer composite film 400 according to yet another embodiment where the hard coat layer is highly filled to form an opaque “black out” film. Such films could be suitable, for example, in paint replacement films for automotive applications. The composite film 400, as depicted, includes a hard coat layer 402 directly coated onto an adhesive layer 414. The hard coat layer 402 differs from those described above in that it is highly filled with a black pigment or dye to render the overall film opaque. In black out film applications, the adhesive layer 414 is commonly a pressure sensitive adhesive layer, but other adhesives are also possible.

Although not illustrated in the above figures, composite films having exposed adhesive layer surfaces (for example, adhesive layers 214, 414) may further include a release liner extending across and contacting the adhesive layer surfaces. The release liner is releasably bonded on at least a portion of the adhesive layer such that the adhesive layer is interposed between the hard coat layer and the release liner. This configuration protects the adhesive layer and facilitates handling of the composite film.

One or more additional layers could be permanently or temporarily disposed on the outward-facing surface of the hard coat layer 102, 202, 302, 402. For instance, the hard coat layer may itself comprise multiple hard coat layers. Like the hard coat layer 102, 202, 302, any of the other layers described herein could be dyed or pigmented to alter the outward appearance of the composite film.

Further details concerning the chemical composition of the aforementioned hard coat layers, second layer (e.g., adhesive layer or polymeric layer), color coatings, primer layers, and other supplemental layers are described below.

### Hard Coat Compositions

Typically on the exposed outer surface of a composite film, the hard coat layer is comprised of a polyurethane layer synthesized by polymerizing at least one polyisocyanate and at least one polyol. More particularly, in a first aspect, a hard coat composition comprises a thermoplastic polyurethane having a hard segment content of 80 percent by weight or greater, wherein the thermoplastic polyurethane is a reaction product of:
a) a diisocyanate;
b) a polyol optionally comprising a cyclic structure; and
c) a chain extender, wherein at least one of the polyol or the chain extender comprises at least one side chain and at least one of the diisocyanate or the chain extender comprises a cyclic structure.

Polyols used in polyurethane synthesis include, for example, polyester polyols, polyether polyols, polycaprolactone polyols, polycarbonate polyols, polyolefin polyols, fatty acid dimer diols, and copolymers and mixtures thereof. Examples of suitable polyols include materials commercially available under the trade designation DESMOPHEN from Covestro LLC (Pittsburgh, Pa.). The polyols can be polyester polyols (for example, DESMOPHEN C1100, C1200, 850, and 1700 or available under the trade designation FOMREZ from Lanxess AG (Cologne, Germany)) or SREPANPOL from Stepan Company (Northfield, Ill.); polyether polyols (for example, DESMOPHEN 1262BD, 1110BD, 1111BD or materials commercially available under the trade designation KURARAY P-500, P-1010, P-2010, P-3010, P-4010, P-5010, P-6010, P-2011, P-520, P-1020, P-2020, P-1012, P-2012, P-530, P-2030, and P-2050 from Kuraray (Tokyo, Japan)); polycaprolactone polyols such as, for example, caprolactone polyols available under the trade designation CAPA from Ingevity (North Charleston, S.C.) (for example, CAPA 2043, 2054, 2100, 2121, 2200, 2201, 2200A, 2200D, 2100A, 3031, 3091, and 3051); polycarbonate polyols (for example, polycarbonate polyols available under the trade designations PC-1122, PC-1167, and PC-1733 from Picassian Polymers (Boston, Mass.), under the trade designation DESMOPHEN C2102, 2202, C XP 2716, C XP 2613 from Covestro LLC, and under the trade designation KURARAY C-590, C-1090, C-2090, and C-3090 from Kuraray); polyolefin polyols (for example polyolefin polyols available from Nippon Soda Co., LTD under the trade designation NISSO-PB); fatty acid dimer diols (for example fatty acid dimer diols (e.g., dimer acids) under the trade designation PRIPOL or PRIPLAST available from Croda Inc (Newark, N.J.).

In some embodiments, the polyol has a number average (Mn) molecular weight of 500 grams per mole (g/mol) or greater, 550 g/mol or greater, 600 g/mol or greater, 650 g/mol or greater, 700 g/mol or greater, 750 g/mol or greater, 800 g/mol or greater, 850 g/mol or greater, 900 g/mol or greater, 950 g/mol or greater, or 1,000 g/mol or greater; and a Mw of 2,000 g/mol or less, 1,900 g/mol or less, 1,800 g/mol or less, 1,700 g/mol or less, 1,600 g/mol or less, 1,500 g/mol or less, 1,400 g/mol or less, 1,300 g/mol or less, 1,200 g/mol or less, or 1,100 g/mol or less.

In some embodiments, the polyol has a structure of the following Formula (I):

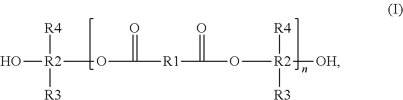

Wherein R¹ and R² are independently selected from a (C₁-C₄₀)alkylene, (C₂-C₄₀)alkenylene, (C₄-C₂₀)arylene, (C₁-C₄₀) acylene, (C₄-C₂₀)cycloalkylene, or (C₄-C₂₀) aralkylene, or (C₁-C₄₀) alkoxyene, which may be substituted or unsubstituted; and R³ and R⁴ are independently selected from —H, —OH, (C₁-C₄₀)alkyl, (C₂-C₄₀)alkenyl, (C₄-C₂₀)aryl, (C₁-C₂₀)acyl, (C₄-C₂₀)cycloalkyl, (C₄-C₂₀)aralkyl, and (C₁-C₄₀)alkoxy, which may be substituted or unsubstituted, and is a positive integer greater than or equal to 1 (for example, greater than 2, 4, 5, or even greater than 10). Suitable substituent groups for any of R¹ through R⁴ include, for instance, alkyl, cyclohexyl, benzyl, aryl, alkoxy, and/or aryloxy.

Specific examples of suitable carboxylic acids according to Formula (I) include glycolic acid (2-hydroxyethanoic acid), lactic acid (2-hydroxypropanoic acid), succinic acid (butanedioic acid), 3-hydoxybutanoic acid, 3-hydroxypentanoic acid, terepthalic acid (benzene-1,4-dicarboxylic acid), naphthalene dicarboxylic acid, 4-hydroxybenzoic acid, 6-hydroxynaphtalane-2-carboxylic acid, oxalic acid, malonic acid (propanedioic acid), adipic acid (hexanedioic acid), pimelic acid (heptanedioic acid), ethanoic acid, suberic acid (octanedioic acid), azelaic acid (nonanedioic acid), sebacic acid (decanedioic acid), glutaric acid (pentanedioic acid), dedecandioic acid, brassylic acid, thapsic acid, maleic acid ((2Z)-but-2-enedioic acid), fumaric acid ((2E)-but-2-enedioic acid), glutaconic acid (pent-2-enedioic acid), 2-decenedioic acid, traumatic acid ((2E)-dodec-2-enedioic acid), muconic acid ((2E,4E)-hexa-2,4-dienedioic acid), glutinic acid, citraconic acid((2Z)-2-methylbut-2-enedioic acid), mesaconic acid ((2E)-2-methyl-2-butenedioic acid), itaconic acid (2-methylidenebutanedioic acid), malic acid (2-hydroxybutanedioic acid), aspartic acid (2-aminobutanedioic acid), glutamic acid (2-aminopentanedioic acid), tartonic acid, tartaric acid (2,3-dihydroxybutanedioic acid), diaminopimelic acid ((2R,6S)-2,6-diaminoheptanedioic acid), saccharic acid ((2S,3S,4S,5R)-2,3,4,5-tetrahydroxyhexanedioic acid), mexooxalic acid, oxaloacetic acid (oxobutanedioic acid), acetonedicarboxylic acid (3-oxopentanedioic acid), arbinaric acid, phthalic acid (benzene-1,2-dicarboxylic acid), isophtalic acid, diphenic acid, 2,6-naphtalenedicarboxylic acid, dimer fatty acid, or a mixture thereof. Preferred acids are terepthalic acid (benzene-1,4-dicarboxylic acid), naphthalene dicarboxylic acid, adipic acid (hexanedioic acid), pimelic acid (heptanedioic acid), suberic acid (octanedioic acid), azelaic acid (nonanedioic acid), sebacic acid (decanedioic acid), dedecandioic acid, phthalic acid (benzene-1,2-dicarboxylic acid), isophtalic acid, dimer fatty acid, or a mixture thereof. The most preferred acids are terepthalic acid (benzene-1,4-dicarboxylic acid), adipic acid (hexanedioic acid), phthalic acid (benzene-1,2-dicarboxylic acid), isophtalic acid, dimer fatty acid, or a mixture thereof.

It has been discovered that the presence of a side chain in the structure of at least one of the polyol or the chain extender advantageously reduces crystallization of the resulting polyurethane, which tends to decrease brittleness of the polyurethane without also decreasing the hardness of the polyurethane. In some embodiments, the polyol comprises a side chain. In some embodiment, the chain extender comprises a side chain. Optionally, both the polyol and the chain extender can have a side chain in their structures. In select embodiments, the polyol includes at least one ring in its structure, i.e., comprises a cyclic structure.

Examples of diisocyanates include: aromatic diisocyanates (for example, 2,6-toluene diisocyanate; 2,5-toluene diisocyanate; 2,4-toluene diisocyanate; m-phenylene diisocyanate; p-phenylene diisocyanate; methylene bis(o-chlorophenyl diisocyanate); methylenediphenylene-4,4′-diisocyanate; polycarbodiimide-modified methylenediphenylene diisocyanate; (4,4′-diisocyanato-3,3′,5,5′-tetraethyl) diphenylmethane; 4,4′-diisocyanato-3,3′-dimethoxybiphenyl (o-dianisidine diisocyanate); 5-chloro-2,4-toluene diisocyanate; and 1-chloromethyl-2,4-diisocyanato benzene), aromatic-aliphatic diisocyanates (for example, m-xylylene diisocyanate and tetramethyl-m-xylylene diisocyanate); aliphatic diisocyanates (for example, 1,4-diisocyanatobutane; 1,6-diisocyanatohexane; 2-methyl-1,5-pentanetlylene diisocyanate; 1,12-dodecane diisocyanate); cycloaliphatic diisocyanates (for example, methylenedicyclohexylene-4,4′-diisocyanate; 3-isocyanatomethyl-3,5,5-trimethylcyclohexyl isocyanate (isophorone diisocyanate); 2,2,4-trimethylhexyl diisocyanate; 1,4-cyclohexanebis(nethylene isocyanate), 1,3-bis(isocyanatomethyl)cyclohexane; and cyclohexylene-1,4-diisocyanate), polymeric or oligomeric compounds (for example, polyoxyalkylene, polyester, polybutadienyl, and the like) terminated by two isocyanate functional groups (for example, the diurethane of toluene-2,4-diisocyanate-terminated polypropylene oxide glycol); polyisocyanates commercially available under the trade designation MONDUR or DESMODUR (for example, DESMODUR XP7100 and DESMODUR 3300) from Covestro LLC (Pittsburgh, Pa.); and combinations thereof.

Of these, particularly advantageous diisocyanates include aliphatic diisocyanates. Aliphatic diisocyanates were generally observed to provide superior weatherability compared with their aromatic counterparts. Particularly preferred species include dicyclohexylmethane diisocyanate, isophorone diisocyanate, hexamethylene diisocyanate, trimethylhexamethylene diisocyanate, tetramethylxylene diisocyanate (TMXDI), 1,4-cyclohexanebis(methylene isocyanate), 1,3-bis(isocyanatomethyl)cyclohexane, 2-methyl-1,5-pentamethylene diisocyanate, 1,12-dodecane diisocyanate, along with copolymers and mixtures thereof. In select embodiments, the diisocyanate includes at least one ring in its structure, i.e., comprises a cyclic structure.

In some embodiments, the chain extender has a weight average molecular weight of at most 400 g/mol, at most 300 g/mol, or at most 200 g/mol. When the chain extender has a weight average molecular weight of at most 185 g/mol and two hydroxyl groups, it is considered a short-chain diol. The size of the chain extender is generally more important than the chemical structure. Without wishing to be bound by theory, it is believed that the relatively small size of the chain extender assists in forming an amorphous structure by helping to minimize or prevent the production of any crystalline structure of a resulting polyurethane. Suitable chain extenders include for instance and without limitation, a diol, a polyester diol, a poly(oxy)alkylenediol with an oxyalkylene group having 2 to 4 carbon atoms, or any combination thereof. Representative examples of suitable chain extenders include 3-methyl-1,5-pentanediol, 1,4-butanediol, ethylene glycol, diethylene glycol, dipropylene glycol, neopentyl glycol, 1,6-hexanediol, 1,4-cyclohexane dimethanol, bis(2-hydroxylethyl)hydroquinone (HQEE), and combinations thereof. 3-Methyl-1,5-pentanediol (MPD), for instance, is commercially available from Tokyo Chemical Industry Co., Ltd. (Tokyo, Japan); 1,4-butanediol is commercially available from BASF (Ludwigshafen, Germany); and 1,4-cyclohexane dimethanol and 1,6-hexanediol are each commercially available from Sigma Aldrich (St. Louis, Mo.). In select embodiments, the chain extender includes at least one ring in its structure, i.e., comprises a cyclic structure.

In preferred embodiments, the thermoplastic polyurethane is substantially non-crosslinked. In these cases, the above diisocyanates and polyols are generally diisocyanates and diols, respectively, where each of these components has a functionality of two. Such functionalities produce long linear polymeric chains that allow the polyurethane material to be reprocessed at elevated temperatures. Notwithstanding, small degrees of crosslinking may be acceptable in some instances.

The linear polymeric chains of a thermoplastic polyurethane generally contain long, low-polarity “soft segments” and shorter, high-polarity “hard segments.” In some embodiments, the soft and hard segments are synthesized in a one-step reaction that includes an isocyanate, short-chain diol, and long-chain diol. Upon conversion, the isocyanate and short-chain diol collectively form the hard segment, while the long-chain diol alone forms the soft segment. At ambient conditions, the hard segments form crystalline or pseudo-crystalline regions in the microstructure of the polyurethane, accounting for its elasticity. The soft segments provide a continuous matrix that enables facile elongation of the polyurethane material. The soft segment portion may or may not be the majority phase of the polyurethane composition.

The long-chain diol has a weight average molecular weight significantly greater than that of the short-chain diol. In some embodiments, for example, the long-chain diol has a weight average molecular weight of at least 500 g/mol, at least 600 g/mol, at least 700 g/mol, at least 800 g/mol, at least 900 g/mol, or at least 950 g/mol.

In some embodiments, the thermoplastic polyurethane has a hard segment content of at least 80 percent, at least 81 percent, at least 82 percent, at least 83 percent, at least 84 percent, at least 85 percent, at least 86 percent, at least 87 percent, at least 88 percent, at least 89 percent, or at least 90 percent by weight, relative to the overall weight of the thermoplastic polyurethane. In some embodiments, the thermoplastic polyurethane has a hard segment content of at most 98 percent, at most 97 percent, at most 96 percent, at most 95 percent, at most 94 percent, at most 93 percent, at most 92 percent, at most 91 percent, at most 90 percent, at most 89 percent, at most 88 percent, at most 87 percent, at most 86 percent, at most 85 percent, at most 84 percent, at most 83 percent, or at most 82 percent, relative to the overall weight of the thermoplastic polyurethane.

The hard segment content can be calculated from the relative weights of the starting materials used in preparing the thermoplastic polyurethane. In the embodiments described herein, the hard segment content is determined using the following formula:

Hard segment wt. %=100%×[wt. of (short-chain diol+diisocyanate)]/[wt. of (polyol+diisocyanate+additives)]

Additives, for instance, can include catalysts and ultraviolet light-related components (e.g., stabilizers, absorbers, etc.) While the relative amounts of long-chain and short-chain diols can vary over a wide range depending on the hardness desired, the overall relative amounts of polyisocyanate to polyol (which includes all diols) are generally selected to be stoichiometric equivalent amounts. In some instances, it may be desired to use an excess of one component, such as polyol, to minimize unreacted remnant of the other component.

It has been unexpectedly discovered that polyurethane hard coat compositions with a hard segment content of 80 wt. % or greater and formed from polyol and/or chain extender structures including at least one side chain, provides improved chemical resistance as compared to polyurethane hard coat compositions with a hard segment content less than 80 wt. % and/or without a side chain in the reactant(s).

The kinetics of the polymerization between the polyisocyanate and polyol species is typically accelerated with the help of a suitable catalyst. In exemplary embodiments, the hard coat composition is prepared using any of a wide variety of known urethane catalysts, including dibutyltin dilaurate, dibutyltin diacetate, stannous octoate, triethylene diamine, zirconium catalysts, and bismuth catalysts.

Other additives can be added in order to enhance the performance of the hard coat compositions. For example, ultraviolet light-related components may include one or more of ultraviolet light (UV) absorbers, radical scavengers, antioxidants, and the like. Such additives and the use thereof are well known in the art. It is understood that any of these compounds can be used so long as they do not deleteriously affect the properties of the hard coat composition. Typical amounts of additives include an amount of about 0.1-5% by weight, about 0.5-4% by weight, or about 1-3% by weight, based on the total weight of the hard coat composition.

Some representative examples of suitable UV absorbers include 5-trifluoromethyl-2-(2-hydroxy-3-alpha-cumyl-5-tert-octylphenyl)-2H-benzo-triazole, 2-(2-hydroxy-3,5-di-alpha-cumylphehyl)-2H-benzotriazole, 5-chloro-2-(2-hydroxy-3-tert-butyl-5-methylphenyl)-2H-benzotiazole, 5-chloro-2-(2-hydroxy-3,5-di-tert-butylphenyl)-2H-benzotriazole, 2-(2-hydroxy-3,5-di-tert-amylphenyl)-2H-benzotriazole, 2-(2-hydroxy-3-alpha-cumyl-5-tert-octylphenyl)-2H-benzotriazole, 2-(3-tert-butyl-2-hydroxy-5-methylphenyl)-5-chloro-2H-benzotriazole, 2(-4,6-diphenyl-1-3,5-triazin-2-yl)-5-hexcyloxy-phenol, and combinations thereof. Some representative examples of suitable radical scavengers include a hindered amine light stabilizer (HALS) compound and/or a hydroxyl amine. One representative suitable antioxidant includes a hindered phenol.

The overall molecular weight of the polyurethane after polymerization should be sufficiently high to provide high strength and elongation properties for thermoforming applications, yet not so high that melt processing of the polymer is unduly complicated. In exemplary embodiments, the aliphatic thermoplastic polyurethane can have a weight average molecular weight of at least 100,000 g/mol, at least 150,000 g/mol, at least 200,000 g/mol, at least 250,000 g/mol, at least 300,000 g/mol, at least 350,000 g/mol, or at least 400,000 g/mol. In exemplary embodiments, the aliphatic thermoplastic polyurethane can have a weight average molecular weight of at most 800,000 g/mol, at most 750,000 g/mol, at most 700,000 g/mol, at most 650,000 g/mol, or at most 600,000 g/mol.

In some embodiments, the thermoplastic polyurethane has a substantially monomodal molecular weight distribution. Such a distribution can be achieved, for example, using the methods disclosed in U.S. Pat. No. 8,128,779 (Ho, et al.). The polydispersity index of the polyurethane, defined as the ratio between the weight average molecular weight and number average molecular weight, can be at least 1.1, at least 1.5, at least 2.0, at least 2.5 or at least 3.0. As to the same or alternative embodiments, the polydispersity index of the polyurethane can be at most 6.0, at most 5.7, at most 5.5, at most 5.2 or at most 5.0.

It is desirable for the disclosed hard coat compositions to display a hardness that is sufficient to avoid or substantially reduce the degradation of its surface finish when subjected to harsh environmental conditions over extended periods of time. For example, for automotive paint protection applications, the hard coat composition should be hard enough to resist scratching from stones, sand, road debris, and bugs during the expected lifetime of the protective film. In exemplary embodiments, the hard coat composition has a Shore D hardness of at least 70, at least 71, at least 72, at least 73, at least 74, at least 75, at least 76, at least 77, at least 78, at least 79, at least 80, at least 81, at least 82, at least 83, at least 84, at least 85, at least 86, at least 87, at least 88, at least 89, at least 90, at least 91, at least 92, at least 93, at least 94, or at least 95.

In some embodiment, the hard coat compositions exhibit a glass transition temperature (T_{g}) of 70 degrees Celsius (° C.) or greater, 75° C. or greater, 80° C. or greater, 85° C. or greater, 90° C. or greater, or 95° C. or greater; and 120° C. or less.

Exemplary embodiments of the hard coat composition have mechanical properties enabling the hard coat layer to be stretched over substrates having complex curvatures in three dimensions. Because of the variety of different substrates that could be encountered, it is desirable for the hard coat composition to be capable of being stretched uniformly over a substantial distance without breaking. At 25 degrees Celsius, the hard coat composition optionally has an Elongation at Break test result (whose specifics shall be defined in the forthcoming Examples) of at least 140 percent, at least 145 percent, at least 150 percent, at least 155 percent, at least 160 percent, at least 165 percent, at least 170 percent, at least 175 percent, at least 180 percent, at least 185 percent, at least 190 percent, at least 200 percent, at least 205 percent, at least 210 percent, at least 215 percent, at least 220 percent, at least 225 percent, at least 230 percent, at least 235 percent, at least 240 percent, at least 245 percent, or at least 250 percent.

The ability of the provided hard coat compositions to elongate without breakage can be substantially enhanced at high temperatures. Further, the degree of enhancement was unexpected. When processed at thermoforming temperatures, for example, films of the provided hard coat composition were observed to be stretched to a far greater extent than that of conventional hard coat films. At 50 degrees Celsius, for example, the provided hard coat compositions can have an elongation at break test result of at least 160 percent, at least 165 percent, at least 170 percent, at least 175 percent, at least 180 percent, at least 185 percent, at least 190 percent, at least 195 percent, at least 200 percent, at least 205 percent, at least 210 percent, at least 215 percent, at least 220 percent, at least 225 percent, at least 235 percent, at least 240 percent, at least 245 percent, at least 250 percent, at least 260 percent, at least 270 percent, at least 280 percent, at least 290 percent, at least 300 percent, at least 310 percent, at least 320 percent, or at least 330 percent.

In dynamic mechanical analysis, tan δ (or the ratio between the storage and loss moduli, E″/E′) is a measure of the amount of deformational energy that is dissipated as heat per cycle at a glass transition temperature of a given polymer. In some embodiments, the provided hard coat compositions display a tan δ peak of at least 0.7, at least 0.75, at least 0.8, at least 0.85, or at least 0.9. In the same or alternative embodiments, the provided hard coat compositions display a tan δ peak of at most 1.5, at most 1.45, at most 1.4, at most 1.35, or at most 1.3.

Polyurethanes with the above tan δ values have performed well in dual vacuum thermoforming applications, while displaying low memory. Memory, which results from polymer molecules being retained in a state of stress after being cooled, can be undesirable in thermoforming applications if it stresses the bond between a hard coat and an underlying layer or substrate. The provided hard coat compositions display glassy, elastic behavior at ambient conditions, characterized by comparatively low tan δ. At 25 degree Celsius, for example, tan δ can be less than 0.4, less than 0.35, less than 0.3, less than 0.25, or less than 0.20.

In some embodiments, dual vacuum thermoforming of the hard coat composition, along with its associated composite film, occurs at a temperature of at least 25, at least 35, at least 40, at least 50, or at least 60 degrees Celsius. In some embodiments, the dual vacuum thermoforming of the composite film occurs at a temperature of at most 180, at most 170, at most 165, at most 160, at most 150, or at most 140 degrees Celsius.

Dual vacuum thermoforming, also sometimes referred to as Three-dimension Overlay Method (“TOM”), can be carried out using any suitable instrument known to one of skill in the art. Such instruments include vacuum molding machines manufactured by Fuse Vacuum Forming Company in Japan. Further aspects of dual vacuum thermoforming are described in U.S. Patent Publication No. 2011/10229681 (Sakamoto et al.).

### Second Layer Compositions

In some embodiments, the second layer 108 is made from a polymer capable of being stretched over a given substrate to be protected, such as an aliphatic thermoplastic polyurethane, polyvinylchloride, or polyethylene terephthalate (PET). For instance, a matte appearance can be provided by using a low gloss PET second layer.

In some embodiments, the second layer 108 comprises an adhesive layer, the composition of which is described in detail below under the heading “Adhesive compositions”.

### Adhesive Compositions

In an exemplary embodiment, the adhesive layer (either as the second layer or as a different layer of a composite film) is a pressure sensitive adhesive that is normally tacky at ambient conditions. Suitable pressure sensitive adhesives can be based on polyacrylates, synthetic and natural rubbers, polybutadiene and copolymers or polyisoprenes and copolymers. Silicone based adhesives such as polydimethylsiloxane and polymethylphenylsiloxane may also be used. Particularly preferred pressure sensitive adhesives include polyacrylate-based adhesives, which can display advantageous properties as high degrees of clarity, UV-stability and aging resistance. Polyacrylate adhesives that are suitable for protective film applications are described, for example, in U.S. Pat. No. 4,418,120 (Kealy et al.); RE24,906 (Ulrich); U.S. Pat. No. 4,619,867 (Charbonneau et al.); 4,835,217 (Haskett et al.); and International Publication No. WO 87/00189 (Bonk et al.).

Preferably, the polyacrylate pressure sensitive adhesive comprises a crosslinkable copolymer of a C₄-C₁₂ alkylacrylate and an acrylic acid. The adhesive can be used with or without a crosslinker. Useful crosslinking reactions include chemical crosslinking and ionic crosslinking. The chemical crosslinker could include polyaziridine and/or bisamide and the ionic crosslinker may include metal ions of aluminum, zinc, zirconium, or a mixture thereof. A mixture of chemical crosslinker and ionic crosslinker can also be used. In some embodiments, the polyacrylate pressure sensitive adhesive includes a tackifier such as rosin ester. Adhesives useful in the invention may also contain additives such as ground glass, titanium dioxide, silica, glass beads, waxes, tackifiers, low molecular weight thermoplastics, oligomeric species, plasticizers, pigments, metallic flakes and metallic powders as long as they are provided in an amount that does not unduly degrade the quality of the adhesive bond to the surface.

As an alternative to pressure sensitive adhesives, the adhesive layer may include a hot melt adhesive, which is not tacky at room temperature but becomes tacky upon heating. Such adhesives include acrylics, ethylene vinyl acetate, and polyurethane materials.

### Color Coating

Examples of colorants include any colorants known in the automotive or graphic arts (for example, high performance or automotive grade pigments (whether colored, white, or black), pearlescent pigments, titanium dioxide, carbon black, metal flakes, dyes, and combinations thereof). Some suitable colorants include dyes, metal flakes, pigments, or combinations thereof. Typically, a colorant is selected to have acceptable lightfastness and weathering characteristics for the intended use of the composite film. When a color coating comprises a polymeric binder and a colorant, the polymeric binder may be a thermoplastic polymer or a thermoset polymer. Examples of polymeric binders include acrylics, urethanes, silicones, polyethers, phenolics, aminoplasts, and combinations thereof. Optionally, a color coating may be formed by printing an ink.

### Primer Layer

In general, for enhanced durability for outdoor usage, a primer layer is formed from a primer composition that is preferably aliphatic, being substantially free of aromatic ingredients. Further, polyurethane and/or acrylic based primer compositions are preferred. Primer compositions for forming a primer layer include water-based primer compositions, solvent-based primer compositions, and 100% solids compositions (e.g. extrudable compositions). Upon evaporation of the solvent (e.g. water and/or organic solvent) and/or upon radiation curing, the primer composition forms a continuous layer. The water-based and solvent-based primer compositions comprise one or more film-forming resins. Various film-forming resins are known. Representative film-forming resins include acrylic resin(s), polyvinyl resins, polyester, polyacrylates, polyurethane and mixtures thereof.

The film forming resin of a solvent-based primer composition is admixed with a solvent. The solvent may be a single substance or a blend of solvents. The primer composition preferably contains about 5 to about 80 parts by weight of the resin, more preferably about 10 to about 50 parts resin and most preferably about 15 to about 30 parts resin, based on the entire primer composition.

The solvent may be a single substance or a blend of solvents. Suitable solvents include water, alcohols such as isopropyl alcohol (IPA) or ethanol; ketones such as methyl ethyl ketone, methyl isobutyl ketone (MIBK), diisobutyl ketone (DEBK); cyclohexanone, or acetone; aromatic hydrocarbons such as toluene; isophorone; butyrolactone; N-methylpyrrolidone; tetrahydrofuran; esters such as lactates, acetates, including propylene glycol monomethyl ether acetate (PM acetate), diethylene glycol ethyl ether acetate (DE acetate), ethylene glycol butyl ether acetate (EB acetate), dipropylene glycol monomethyl acetate (DPM acetate); iso-alkyl esters such as isohexyl acetate, isoheptyl acetate, isooctyl acetate, isononyl acetate, isodecyl acetate, isododecyl acetate, isotridecyl acetate or other iso-alkyl esters; combinations of these, and the like.

Preferred solvent-based and water-based primer compositions comprise at least about 25 percent by weight of the dry resin of an acrylic resin, and preferably at least about 50 percent by weight. Other preferred solvent-based and water-based primer compositions comprise at least about 10 percent by weight of the dry resin of a polyurethane, and preferably at least about 25 percent by weight. An exemplary solvent-based primer is commercially available from 3M under the trade designation “8801 Toner for Scotchlite Process Color Series Inks”. Further, exemplary compositions for use as water-based primers include sulpho poly(ester urethane) compositions, such as described in U.S. Pat. No. 5,929,160 (Krepski et al.).

### Methods of Making

The manufacture of the composite films shown in FIGS. 1-4 involves forming two or more layers, as described, that are subsequently coupled to each other. The layers constituting the composite films may be prepared in parallel or in series.

The hard coat layer in particular may be formed using conventional techniques known to those of ordinary skill in the art. Such techniques include, for example, coating or extruding onto a substrate. One skilled in the art can coat or extrude the disclosed hardenable compositions onto a substrate using either batch or continuous techniques.

In a preferred method, a thermoplastic polyurethane layer is formed by extruding it at an elevated temperature through an extrusion die. The thermoplastic polyurethane layer may also be formed by casting or otherwise molding (for example, injection molding) the thermoplastic polyurethane into the shape desired.

If desired, the hard coat layer and one or more intermediate layers may be coupled by laminating the layers to each other at elevated temperature and pressure. For example, one major surface of the hard coat layer may be cold laminated under pressure to one major surface of the intermediate layer, while at least the one major surface of the hard coat layer is, or both the hard coat layer and the intermediate layer are at an elevated temperature that is sufficiently high to facilitate adequate bonding between the two layers. In a “cold laminating” process, the layers are laminated together between two nip surfaces near an ambient temperature environment (that is, the layers are not kept in an intentionally heated environment during the laminating process).

Advantageously, the use of chilled surfaces may eliminate, or at least help reduce, warping of the layers resulting from the laminating process. At the same time, the major surfaces that make contact at the interface between the polyurethane layers remain at the elevated temperature long enough to be sufficiently bonded together by the laminating pressure exerted by the nip surfaces. Cold laminating may be accomplished by laminating a newly extruded hard coat layer directly onto a preformed intermediate layer, while the hard coat composition retains significant heat from the extrusion process. Optionally, the intermediate layer is releasably bonded to a carrier web or liner to provide additional structural strength.

Alternatively, the hard coat layer may be bonded to an intermediate layer along their respective major surfaces using a hot laminating process. In this process, the initial temperatures of the layers are too low to sustain adequate bonding between them and at least one major surface of either the hard coat layer, intermediate layer, or both is heated and pressure applied to facilitate bonding between the hard coat layer and the intermediate layer. Typically, minimum temperatures and pressures for bonding the layers together using either the cold or hot laminating process, are at least about 93 degrees Celsius and at least about 10.3 N/cm², respectively.

In some embodiments, it may be desirable to corona treat (using, for example, air or nitrogen), a major surface of an extruded hard coat layer prior to bonding the major surface to an adhesive layer. Such treatment can improve adhesion between the hard coat layer and the adhesive layer.

Further details relating to the fabrication and processing of the hard coat compositions described herein are described in U.S. Pat. No. 8,128,779 (Ho et al.).

The provided hard coat compositions and composite films can be further exemplified by the following embodiments:

In a first embodiment, the present disclosure provides a hard coat composition. The hard coat composition comprises a thermoplastic polyurethane having a hard segment content of 80 percent by weight or greater. The thermoplastic polyurethane is a reaction product of a) a diisocyanate, b) a polyol optionally comprising a cyclic structure, and c) a chain extender. At least one of the polyol or the chain extender comprises at least one side chain and at least one of the diisocyanate or the chain extender comprises a cyclic structure.

In a second embodiment, the present disclosure provides a hard coat composition according to the first embodiment, wherein the hard segment content is 90 percent by weight or greater.

In a third embodiment, the present disclosure provides a hard coat composition according to the first embodiment or the second embodiment, wherein the diisocyanate is selected from the group consisting of: dicyclohexylmethane diisocyanate, isophorone diisocyanate, hexamethylene diisocyanate, trimethylhexamethylene diisocyanate, tetramethylxylene diisocyanate (TMXDI), 1,4-cyclohexanebis(methylene isocyanate), 1,3-bis(isocyanatomethyl)cyclohexane, 2-methyl-1,5-pentamethylene diisocyanate, 1,12-dodecane diisocyanate, and copolymers and mixtures thereof.

In a fourth embodiment, the present disclosure provides a hard coat composition according to any of the first through third embodiments, wherein the diisocyanate comprises a cyclic structure.

In a fifth embodiment, the present disclosure provides a hard coat composition according to any of the first through fourth embodiments, wherein the chain extender has a weight average molecular weight of at most 200 g/mol.

In a sixth embodiment, the present disclosure provides a hard coat composition according to any of the first through fifth embodiments, wherein the chain extender comprises a diol, a polyester diol, a poly(oxy)alkylenediol with an oxyalkylene group having 2 to 4 carbon atoms, or combinations thereof.

In a seventh embodiment, the present disclosure provides a hard coat composition according to any of the first through sixth embodiments, wherein the chain extender comprises a cyclic structure.

In an eighth embodiment, the present disclosure provides a hard coat composition according to any of the first through seventh embodiments, wherein the polyol is selected from the group consisting of polyester polyols, polycaprolactone polyols, polycarbonate polyols, polyether polyols, polyolefin polyols, fatty acid dimer diols, and copolymers and mixtures thereof.

In a ninth embodiment, the present disclosure provides a hard coat composition according to any of the first through eighth embodiments, wherein the polyol comprises a cyclic structure.

In a tenth embodiment, the present disclosure provides a hard coat composition according to any of the first through ninth embodiments, wherein the polyol has a molecular weight of 500 g/mol or greater, 600 g/mol or greater, 700 g/mol or greater, 800 g/mol or greater, 900 g/mol or greater, or 1,000 g/mol or greater.

In an eleventh embodiment, the present disclosure provides a hard coat composition according to any of the first through tenth embodiments, wherein the polyol has a structure of the following Formula (I):

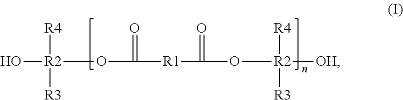

wherein R¹ and R² are independently selected from (C₁-C₄₀)alkylene, (C₂-C₄₀)alkenylene, (C₄-C₂₀)arylene, (C₁-C₄₀)acylene, (C₄-C₂₀)cycloalkylene, (C₄-C₂₀)aralkylene, or (C₁-C₄₀)alkoxyene, which may be substituted or unsubstituted; and R³ and R⁴ are independently selected from —H, (C₁-C₄₀)alkyl, (C₂-C₄₀)alkenyl, (C₄-C₂₀)aryl, (C₁-C₂₀)acyl, (C₄-C₂₀)cycloalkyl, (C₄-C₂₀)aralkyl, and (C₁-C₄₀)alkoxy, which may be substituted or unsubstituted; and n is a positive integer greater than or equal to 1 (for example, greater than 2, 4, 5, or even 10).

In a twelfth embodiment, the present disclosure provides a hard coat composition according to any of the first through eleventh embodiments, wherein the polyol comprises a side chain.

In a thirteenth embodiment, the present disclosure provides a hard coat composition according to any of the first through twelfth embodiments, wherein the chain extender comprises a side chain.

In a fourteenth embodiment, the present disclosure provides a hard coat composition according to any of the first through thirteenth embodiments, wherein the polyol comprises terepthalic acid (benzene-1,4-dicarboxylic acid), naphthalene dicarboxylic acid, adipic acid (hexanedioic acid), pimelic acid (heptanedioic acid), suberic acid (octanedioic acid), azelaic acid (nonanedioic acid), sebacic acid (decanedioic acid), dedecandioic acid, phthalic acid (benzene-1,2-dicarboxylic acid), isophtalic acid, dimer fatty acid, or a mixture thereof.

In a fifteenth embodiment, the present disclosure provides a hard coat composition according to any of the first through fourteenth embodiments, wherein the polyol comprises terepthalic acid (benzene-1,4-dicarboxylic acid), adipic acid (hexanedioic acid), phthalic acid (benzene-1,2-dicarboxylic acid), isophtalic acid, dimer fatty acid, or a mixture thereof.

In a sixteenth embodiment, the present disclosure provides a hard coat composition according to any of the first through fifteenth embodiments, exhibiting a Shore D hardness of 80 or greater.

In a seventeenth embodiment, the present disclosure provides a hard coat composition according to any of the first through sixteenth embodiments, exhibiting a glass transition temperature (T_{g}) of 70 degrees Celsius (° C.) or greater, 75° C. or greater, 80° C. or greater, 85° C. or greater, 90° C. or greater, or 95° C. or greater.

In an eighteenth embodiment, the present disclosure provides a composite film. The composite film comprises 1) a hard coat layer comprising opposing first and second major surfaces; and 2) a second layer disposed on at least a portion of the hard coat layer. The hard coat layer comprises a thermoplastic polyurethane having a hard segment content of 80 percent by weight or greater. The thermoplastic polyurethane is a reaction product of a) a diisocyanate, b) a polyol optionally comprising a cyclic structure, and c) a chain extender. At least one of the polyol or the chain extender comprises at least one side chain and at least one of the diisocyanate or the chain extender comprises a cyclic structure.

In a nineteenth embodiment, the present disclosure provides a composite film according to the eighteenth embodiment, wherein the second layer is an adhesive layer.

In a twentieth embodiment, the present disclosure provides a composite film according to the nineteenth embodiment, wherein the adhesive layer comprises a pressure sensitive adhesive, a hot melt adhesive, or a combination thereof.

In a twenty-first embodiment, the present disclosure provides a composite film according to the eighteenth embodiment, wherein the second layer is a polymeric layer.

In a twenty-second embodiment, the present disclosure provides a composite film according to the twenty-first embodiment, wherein the polymeric layer comprises polyethylene terephthalate (PET) or a polyurethane.

In a twenty-third embodiment, the present disclosure provides a composite film according to the eighteenth through twenty-second embodiments, further comprising a color coating disposed between the hard coat layer and the second layer.

In a twenty-fourth embodiment, the present disclosure provides a composite film according to the twenty-third embodiment, further comprising a primer layer disposed between the color coating and the hard coat layer.

In a twenty-fifth embodiment, the present disclosure provides a composite film according to the any of the eighteenth through twenty-fourth embodiments, wherein the hard coat layer comprises the hard coat composition of any of the first through seventeenth embodiments.

### EXAMPLES

Unless otherwise noted or apparent from the context, all parts, percentages, ratios, etc. in the Examples and the rest of the specification are by weight. Table 1 (below) lists materials used in the examples and their sources.

TABLE 1
Materials List

| DESIGNATION | DESCRIPTION | SOURCE |
|---|---|---|
| 1,4-CHDM | 1,4-Cyclohexanedimethanol, mixture of cis and | Sigma-Aldrich, St. |
| | trans, 99% | Louis, MO |
| 1,6-hexendiol | Chain extender diol, 99% pure | Sigma-Aldrich |
| KP-1020 | Polyester polyol (MPD-terephthalate), | Kuraray, Tokyo, |
| | molecular weight = 1000 g/mol; obtained under | Japan |
| | the trade designation “KURARAY POLYOL | |
| | P-1020” | |
| C2100A | Caprolactone polyol, molecular weight = 1000 | Perstorp AB, Malmö, |
| | g/mol; obtained under the trade designation | Sweden |
| | “CAPA 2100A” | |
| F44-111 | Polyester polyol, molecular weight = 1000 | Chemtura, |
| | g/mol; obtained under the trade designation | Philadelphia, PA |
| | “FOMREZ 44-111” | |
| 1,4-butanediol | Chain extender diol, 99.8% pure | BASF, |
| | | Ludwigshafen, |
| | | Germany |
| T292 | Liquid hindered amine obtained under the trade | BASF |
| | designation “TINUVIN 292” | |
| T571 | UV light stabilizer obtained under the trade | BASF |
| | designation “TINUVIN 571” | |
| DT12 | Dibutyl tin dilaurate catalyst obtained under the | Air Products, |
| | trade designation “DABCO T12 CATALYST” | Allentown, PA |
| DES-W | Liquid cycloaliphatic diisocyanate obtained | Covestro, |
| | under the trade designation “DESMODUR W” | Leverkusen, |
| | | Germany |
| DMF | Dimethylformamide, 99.9% pure | Sigma-Aldrich, St. |
| | | Louis, MO |

### Test Methods

### Hardness Test Method

The Shore D hardness of the hard coat layer of the composite films was measured according to ASTM D2240-05 test protocol.

### Gel Permeation Chromatography (GPC) Molecular Weight/Distribution Analysis Test Method

Average molecular weight and molecular weight distribution of prepared polyurethane materials were obtained generally using the procedure described in ASTM D5296-11. The instrument used was a Model 1100 from Agilent Technologies, Hewlett-Packard-Strasse, Waldbronn, Germany. The column set was 2×Jordi Gel DVB Mixed Bed (15 cm×4.6 mm I.D.) and the detector was differential refractor index (DRI). 10 milliliters (mL) of chloroform was added to approximately 25-30 milligrams (mg) of sample to give solutions of approximately 0.25-0.3% w/v concentration. Solutions were swirled for at least 14 hours and then filtered using 0.2 micron PTFE syringe filters. 30 microliters was injected and the eluent was collected at 0.3 milliliter per minute. The weight average molecular weight was reported along with polydispersity.

### Dynamic Mechanical Thermal Analysis Test Method

The elastic moduli of thermoplastic films were measured from −50° C. to 150° C. in tension using Rheometric's Solid Analyzer (RSA II) at 1 Hz (6.28 radians/second). A typical thin strip of sample 6.865 millimeter (mm) width by 22.8 mm length and thickness range from 0.012 mm to 0.022 mm was mounted in the clamps and tightened. Pre-determined amplitude and frequency was applied to the thin film sample and the stress response of the material was measured. The glass transition temperature (T_{g}) was obtained at the maximum of Tan delta.

### Staining Test Method

Color change (delta E) was measured after staining tests were performed.

A 50% by volume mixture of Marathon Oil AC-20 non-emulsified asphalt cement (Marathon, Houston, Tex.) was prepared in unleaded gasoline. The specimens were dipped into the test fluid for 10 seconds. The specimens were then suspended in a ventilated hood test chamber for 15 minutes allowing the solution to drain/evaporate. After 15 minutes, the specimens were cleaned thoroughly with naphtha. The color change before and after the staining test was measured by a colorimeter (Color i5 from X-rite, Grand Rapids, Mich.) according to ASTM E1347 (2020), and Aa color change from red to green, ΔL color change from black to white, Ab color change from yellow to blue, and ΔE total color change were reported.

### Chemical Exposure Test Method

Various chemicals, such as sunscreen (sun protection factor (SPF) 8 or SPF 70), 30% phosphoric acid, 1% nitric acid, 1% sulfuric acid, or caustic soda were individually dropped on the film surfaces with a spot size of 10 millimeter (mm) dimeter. Then film samples were then placed in an oven for 30 minutes at 85° C. After 30 minutes, the specimens were removed from the oven and cleaned thoroughly with detergent and clear water and then dried. A designation of “PASS” means there was no mark left on the surface. A designation as “FAIL” means that the film surface was damaged or swollen.

### EXAMPLES

### Comparative Example A (Comp Ex-A)

A polyester polyol and fatty acid dimer-based thermoplastic polyurethane hard coat composition was prepared by individually feeding polyester polyol FOMREZ 44-111, 1,4-butanediol, TINUVIN 292, TINUVIN 571, DABCO T12 as Part A, and DESMODUR W as part B, in a co-rotating twin screw extruder. The extruder was a 58-mm co-rotating twin screw extruder (available from Davis-Standard, Pawcatuck, Conn., USA). The extruder had 13 barrel zones that were independently heated. A vacuum pump was applied to the extruder. The barrel temperatures, die, and neck tube temperatures, are listed in the table below. A 66 cm wide drop die was connected to the output end of the twin screw extruder.

Extrusion Conditions
Extruder RPM (RPM): 135

Zone 2: 193° C.
Zone 3: 193° C.
Zone 4: 193° C.
Zone 5: 188° C.
Zone 6: 182° C.
Zone 7: 177° C.
Zone 8: 160° C.
Zone 9: 160° C.
Zone 10: 150° C.
Zone 11: 150° C.
Zone 12: 150° C.
Zone 13: 150° C.
Neck Tube Temp: 163° C.
Die Temp: 163° C.

The detailed weight percent of the components are summarized in Table 2. The polymerized mixture was extruded using a standard drop die and cast onto a polyester film (50 micrometer oriented polyester film) at a thickness of approximately 25 micrometers and 64 centimeter in width. The melt curtain was cast vertically into a nip consisting of a rubber roll and a metal casting roll and then wound into a roll. The Shore D hardness of the polyurethane was 65D.

TABLE 2
Formulations and properties of extruded thermoplastic hard coats

| | |
|---|---|
| Comp Ex-A | Comp Ex-B |

Part A

| | | |
|---|---|---|
| C2100A, wt. % | 0.00% | 62.60% |
| F44-111, wt. % | 62.60% | 0.00% |
| 1,4-butanediol, wt. % | 27.20% | 27.20% |
| DT12, wt. % | 0.30% | 0.30% |
| T292, wt. % | 4.00% | 4.00% |
| T571, wt. % | 6.00% | 6.00% |

Part B

| | | |
|---|---|---|
| DES-W, | 80.00% | 100.00% |
| wt. % relative to Part A | | |

Properties

| | | |
|---|---|---|
| NCO/OH Curing Ratio | 1.04/1 | 1.04/1 |
| Hard Segment, wt. % | 59.50% | 63.60% |
| Shore Hardness | 65D | 80D |
| Wt. Average Molecular | — | 551,000 |
| Weight, g/mol | | |
| Polydispersity | — | 4.38 |
| T_{g}, ° C. | 53.4 | 62.4 |

### Comparative Example B (Comp Ex-B)

Polyurethane film Comparative Example B was extruded as described in Comparative Example A except the composition was adjusted as described in Table 2, above.

### Comparative Examples C to E (Comp Ex-C to E)

On top of the hard coat Comparative Examples prepared above, a soft polyurethane prepared from a polyester polyol was extruded (Comparative Example C). The formulation for the polyester polyol based on soft thermoplastic polyurethane is summarized in Table 3. All 6 ingredients were individually feed into the co-rotating twin screw extruder. The polymerization was completed in the barrels and the film was extruded out of the die directly onto the hard coat films at about 5 mil (about 127 micrometers) thickness. The total thickness was about 6 mil (about 162 micrometers). It was then laminated to a 2 mil (51 micrometers) acrylic pressure sensitive adhesive. The polyester carrier web was stripped off. The shore A hardness of the soft polyurethane was about 90 A.

TABLE 3
Formulation of extruded thermoplastic soft polyurethanes

Comp Ex-C

Part A

| | |
|---|---|
| C2100A, wt. % | 0.00% |
| F44-111, wt. % | 78.85% |
| 1,4-butanediol, wt. % | 16.00% |
| DT12, wt. % | 0.15% |
| T292, wt. % | 2.00% |
| T571, wt. % | 3.00% |

Part B

| | |
|---|---|
| DES-W, wt. % relative to Part A | 70.00% |

Properties

| | |
|---|---|
| NCO/OH Curing Ratio | 1.04/1 |
| Hard Segment, wt. % | 50.60% |
| Shore Hardness | 90A |

TABLE 4
Thermoplastic soft polyurethane with a thermoplastic
polyurethane hard coat on top

| | | Thermoplastic soft |
|---|---|---|
| Comparative Example | Hard coat (1 mil) | polyurethane (5 mil) |
| Comp Ex-D | Comp Ex-A | Comp Ex-C |
| Comp Ex-E | Comp Ex-B | Comp Ex-C |

### Example 1 (EX-1)

To a resin reaction vessel equipped with a mechanical stirrer, a condenser, and a nitrogen inlet, 62.5 gram (g) of KP-1020 and 200 g of DMF were added. The solution was heated up to 75° C., and 0.09 g DT12 and 99.79 g of DES-W was added while stirring. The temperature was maintained at 75±2° C. until the NCO content reached the theoretical NCO value, which was determined by utilizing a standard dibutylamine back titration method. Upon obtaining the theoretical NCO value, the polyurethane was then chain extended by adding 28.02 g of 1,4-butanediol and was allowed to react until no intensity or intensity change of the NCO group was observed by FT-IR. During the reaction, an additional 170 g of DMF was added to adjust the solids content to around 35 wt. %, resulting in clear and transparent polyurethane solution.

A thermoplastic polyurethane hard coat was made from the EX-1 formulation described above. A solution of the thermoplastic polyurethane in DMF was casted on a PET carrier web by using a RDS #18 Mayer bar (RD Specialties, Inc., Webster, N.Y.) and dried in an oven set to 90° C. for 5 minutes to obtain the clear coat coated film. The hard coat was then thermally laminated to a polyurethane input film at 235° F. (113° C.). The polyurethane input film was comprised of (1) a polyurethane film extruded from commercially available Lubrizol Estane CLA87A resin pellets (Wickliffe, Ohio), (2) an acrylic pressure sensitive adhesive, and (3) a polyester release liner. The nip roll pressure was set at 40 pounds per square inch (psi) and the line speed was 12 feet/minute (3.66 meters/minute). The PET carrier web was stripped off to yield the hard coat on the polyurethane input film.

TABLE 5
Formulations and properties of extruded thermoplastic hard coats

| | EX-1 | | EX-2 | | EX-3 | | EX-4 | |
|---|---|---|---|---|---|---|---|---|
| KP-1020, g (wt. %) | 62.5 | (32.8%) | 64.5 | (30.8) | 25 | (20.0%) | 10.65 | (10.0%) |
| DMF, g | 200 | | 200 | | 100 | | 100 | |
| DT12, g (wt. %) | 0.09 | (0.05%) | 0.11 | (0.05%) | 0.06 | (0.05%) | 0.06 | (0.05%) |
| DES-W, g (wt. %) | 99.79 | (52.4%) | 99.79 | (47.6) | 67.69 | (54.2%) | 63.81 | (59.9%) |
| 1,4-butanediol, g | 28.02 | (14.7%) | | | | | | |
| (wt. %) | | | | | | | | |
| 1,4-CHDM, g | | | 45.14 | (21.5%) | 32.0 | (25.6%) | 32.0 | (30%) |
| (wt. %) | | | | | | | | |

| | | | | |
|---|---|---|---|---|
| Additional DMF, g | 170 | 365 | 290 | 320 |

Properties

| NCO/OH Curing | 1.01/1 | | 1.01/1 | | 1.04/1 | | 1.04/1 | |
|---|---|---|---|---|---|---|---|---|
| Ratio | | | | | | | | |
| Wt. Average | 119,000 | | 135,000 | | 317,000 | | 326,000 | |
| Molecular Weight, | | | | | | | | |
| g/mol | | | | | | | | |
| T_{g}, ° C. | 78 | | 77 | | 86 | | 95 | |
| Hard Segment, wt. % | 67 | wt. % | 69 | wt. % | 80 | wt. % | 90 | wt. % |
| Solids content, wt. % | 35 | wt. % | 27 | wt. % | 25 | wt. % | 20 | wt. % |

### Examples 2-4 (EX-2 to 4)

Additional polyurethane formulations were prepared and extruded as described in Example 1, except the compositions were adjusted as described in Table 5, above.

TABLE 6
Chemical resistance performance of multilayer films

| | | | | | Comp | Comp |
|---|---|---|---|---|---|---|
| Example | EX-1 | EX-2 | EX-3 | EX-4 | Ex-D | Ex-E |
| Asphalt | ΔE = 4.11 | ΔE = 3.49 | ΔE = 1.96 | ΔE = 0.66 | ΔE = 2.76 | ΔE = 3.47 |
| after | ΔL = −0.31 | ΔL = −0.38 | ΔL = −0.25 | ΔL = 0.0 | ΔL = −0.21 | ΔL = −0.09 |
| VM&P | Δa = −1.37 | Δa = −1.22 | Δa = −0.66 | Δa = −0.23 | Δa = −1.08 | Δa = −1.33 |
| Cleaned | Δb = 3.86 | Δb = 3.25 | Δb = 1.82 | Δb = 0.62 | Δb = 2.53 | Δb = 3.20 |
| Sunscreen | Fail | Fail | Some | Very slight | Fail | Very slight |
| SPF8 | | | Swelling | swelling | | swelling |
| 10 minutes | | | | | | |
| at 85° C. | | | | | | |
| Sunscreen | Fail | Fail | Fail | Fail | Fail | Fail |
| SPF 70 | | | | | | |
| 10 minutes | | | | | | |
| at 85° C. | | | | | | |
| 30% | Fail | Fail | Pass | Pass | Fail | Fail |
| Phosphoric | | | | | | |
| Acid 30 | | | | | | |
| minutes | | | | | | |
| at 85° C. | | | | | | |
| 1% Nitric | Pass | Pass | Pass | Pass | Pass | Pass |
| Acid 30 | | | | | | |
| minutes | | | | | | |
| at 85° C. | | | | | | |
| 1% | Some | Some | Pass | Pass | Pass | Pass |
| Sulfuric | Swelling | Swelling | | | | |
| Acid 30 | | | | | | |
| minutes | | | | | | |
| at 85° C. | | | | | | |
| Caustic | Pass | Pass | Very slight | Very slight | Pass | Pass |
| Soda 30 | | | swelling | swelling | | |
| minutes | | | | | | |
| at 85° C. | | | | | | |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to he construed as limiting the scope of the disclosure, which is defined by the claims and their equivalents.

1. A hard coat composition comprising a thermoplastic polyurethane having a hard segment content of 80 percent by weight or greater, wherein the thermoplastic polyurethane is a reaction product of:
a) a diisocyanate;
b) a polyol optionally comprising a cyclic structure, wherein the polyol has a number average (Mn) molecular weight of 500 grams per mole (g/mol) or greater; and
c) a chain extender, wherein at least one of the polyol or the chain extender comprises at least one side chain and at least one of the diisocyanate or the chain extender comprises a cyclic structure.

2. The hard coat composition of claim 1, wherein the hard segment content is 90 percent by weight or greater.

3. The hard coat composition of claim 1, wherein the diisocyanate is selected from the group consisting of: dicyclohexylmethane diisocyanate, isophorone diisocyanate, hexamethylene diisocyanate, trimethylhexamethylene diisocyanate, tetramethylxylene diisocyanate (TMXDI), 1,4-cyclohexanebis(methylene isocyanate), 1,3-bis(isocyanatomethyl)cyclohexane, 2-methyl-1,5-pentamethylene diisocyanate, 1,12-dodecane diisocyanate, and copolymers and mixtures thereof.

4. The hard coat composition of claim 1, wherein the diisocyanate comprises a cyclic structure.

5. The hard coat composition of claim 1, wherein the chain extender comprises a diol, a polyester diol, a poly(oxy)alkylenediol with an oxyalkylene group having 2 to 4 carbon atoms, or combinations thereof.

6. The hard coat composition of claim 1, wherein the chain extender comprises a cyclic structure.

7. The hard coat composition of claim 1, wherein the polyol is selected from the group consisting of: polyester polyols, polycaprolactone polyols, polycarbonate polyols, polyether polyols, polyolefin polyols, fatty acid dimer diols, and copolymers and mixtures thereof.

8. The hard coat composition of claim 1, wherein the polyol comprises a side chain.

9. The hard coat composition of claim 1, wherein the polyol has a structure of the following Formula (I): 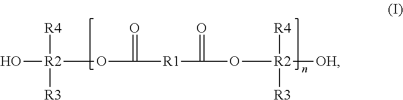
wherein R¹ and R² are independently selected from (C₁-C₄₀)alkylene, (C₂-C₄₀)alkenylene, (C₄-C₂₀)arylene, (C₁-C₄₀)acylene, (C₄-C₂₀)cycloalkylene, (C₄-C₂₀)aralkylene, or (C₁-C₄₀)alkoxyene, which may be substituted or unsubstituted; and R³ and R⁴ are independently selected from —H, (C₁-C₄₀)alkyl, (C₂-C₄₀)alkenyl, (C₄-C₂₀)aryl, (C₁-C₂₀)acyl, (C₄-C₂₀)cycloalkyl, (C₄-C₂₀)aralkyl, and (C₁-C₄₀)alkoxy, which may be substituted or unsubstituted; and n is a positive integer greater than or equal to 1.

10. A composite film comprising:
1) a hard coat layer comprising opposing first and second major surfaces, the hard coat layer comprising a thermoplastic polyurethane having a hard segment content of 80 percent by weight or greater, wherein the thermoplastic polyurethane is a reaction product of a) a diisocyanate, b) a polyol optionally comprising a cyclic structure, wherein the polyol has a number average (Mn) molecular weight of 500 g/mol or greater, and c) a chain extender, wherein at least one of the polyol or the chain extender comprises at least one side chain and at least one of the diisocyanate or the chain extender comprises a cyclic structure; and
2) a second layer disposed on at least a portion of the hard coat layer.

11. The composite film of claim 10, wherein the second layer is an adhesive layer.

12. The composite film of claim 11, wherein the adhesive layer comprises a pressure sensitive adhesive, a hot melt adhesive, or a combination thereof.

13. The composite film of claim 10, wherein the second layer is a polymeric layer.

14. The composite film of claim 10, further comprising a color coating disposed between the hard coat layer and the second layer.

15. (canceled)
